(19) United States
(12) Patent Application Publication
(10) Pub. No.: US 2011/0121081 A1
(43) Pub. Date: May 26, 2011

(54) FINANCIAL CARD HAVING INTEGRATED BALANCE CALCULATION

(76) Inventors: Gary Beasley, Menifee, CA (US); Richard L. Campbell, Menifee, CA (US)

(21) Appl. No.: 12/625,285

(22) Filed: Nov. 24, 2009

(51) Int. Cl. G06K 19/067

(52) U.S. Cl. 235/492; 235/487

(57) ABSTRACT

An electronically operated card such as a debit or credit card, having internal data handling capabilities. The card may include in addition to a conventional magnetic strip, a data processor, a display, an on-off switch which may be a biometric switch, a power supply which may comprise a capacitor with or without a photovoltaic cell, and data busses enabling communication with external devices. The card may be used in combination with an external docking station which may be communicably connected to personal computers and to communications devices such as cellular telephones. The data processor may have programming enabling the card to perform functions which may be conventionally performed at card swiping terminals, automatic teller machines, and the like, such as balance reporting, funds transfers, purchase authorizations, displaying notices from such terminals and machines, and the like.

### FIELD OF THE INVENTION

The present invention relates to financial cards which are able to operate electronic payment processing devices, such as credit cards and debit cards, and more particularly, to financial cards which have both internal processing capabilities and also ability to transfer data externally.

### BACKGROUND OF THE INVENTION

It has become commonplace to conduct financial transactions using small cards, typically made from plastic and provided with magnetic strips for signalling identity of the user to a data processing device or system, so that operation of the data processing device or system is properly authorized. Credit and debit cards exemplify such cards, but other examples exist, such as cards for operating controlled entry systems.

The card typically functions as a key giving the cardholder operating access to the associated system. Most systems have keypads, touchscreens, or corresponding human-to-machine interface devices. The actual transaction is processed by utilizing the keypad or touchscreen. Even in systems that are highly automated, such as point of sale terminals in retail stores, the card serves the function of enabling aspects of the transaction, which transaction is then performed by the larger system.

There exists an opportunity to expand the function of credit, debit, and like cards.

### SUMMARY OF THE INVENTION

The present invention greatly expands the capabilities and functions of devices which operate as and appear as credit, debit, and like cards. Miniaturized electronic components are added to provide data processing and display capabilities on the card. The resultant novel card may then act as a data processing and communications device, and not serve only in the passive role of an electronic key for merely enabling operation of data handling systems.

An exemplary use of the novel card is to interface with and control automatic teller machines. Data may be transferred, such as by linking an automatic teller machine account with another account to effect funds transfer. Data pertaining to account status, such as balances, may be displayed on the card and retained within the card. Therefore, the user may view this data even after leaving the vicinity of the automated teller machine or other data handling system. The data may also be transferred to other data handling devices, such as personal computers and cellular telephones, using the novel card.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a plan view of a personal account card according to at least one aspect of the invention.

FIG. 2 is a perspective detail view showing a mobile docking station for a personal account card according to at least one aspect of the invention, and a personal account card in a position about to enter the mobile docking station.

FIG. 3 is an exploded environmental perspective view of a personal account card and a mobile docking station illustrating certain exemplary external data handling devices which may be operably compatible with the personal account card and the mobile docking station.

### DETAILED DESCRIPTION

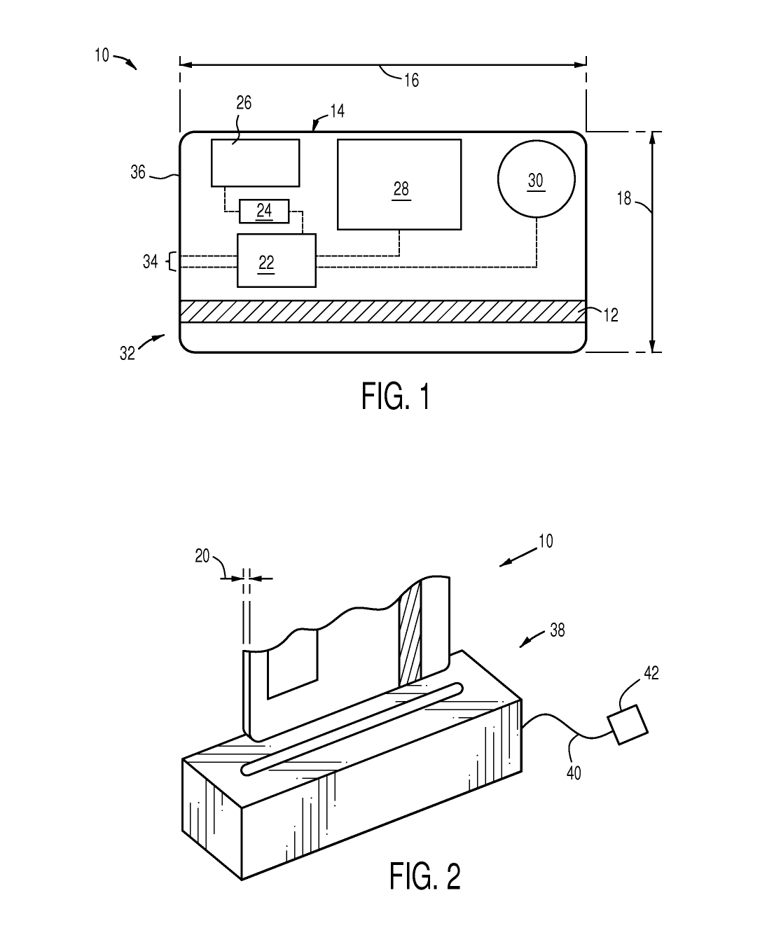

Referring first to FIG. 1, according to at least one aspect of the invention, there is shown a personal account card 10 of the type having machine readable element, such as identity indicia, disposed thereon, such as a magnetic strip 12, for activating an external data handling system having a data terminal including a card reader (to be shown and described hereinafter). The personal account card 10 may comprise a flat thin body 14 made from plastic, for example, having length 16, width 18, and nominal thickness 20 (shown in FIG. 2). The flat thin body 14 may be essentially similar to those of conventional credit, debit, and access cards used with card readers (these exemplary devices are not shown).

The magnetic strip 12 may be located on the exterior of the body 14 of the personal account card 10 may be located on the flat thin body and may be disposed to communicate a unique identity to the card reader in conventional manner.

The personal account card 10 may comprise an internal data processor 22, which will be understood to comprise memory and data processing functionality, and a power supply disposed to provide operating power to the internal data processor 22 and to other electrically operated components of the personal account card 10. The power supply may comprise an electrical power storage device such as a miniature battery cell (not shown), a capacitor 24, a photovoltaic cell 26, or a combination of these. A capacitor such as the capacitor 24 may be of any known type, such as a supercapacitor, an electric double layer capacitor, and others.

The personal account card 10 may comprise a display screen which is operably connected to the internal data processor 22, such as a liquid crystal display 28.

Operation of the internal data processor 22 may be controlled by an on-off switch. The on-off switch may be a biometric switch 30 which may be for example of the type using operating principles shown in U.S. Pat. No. 6,182,892, issued to Michael F. Angelo et al. on Feb. 6, 2001. This document is explicitly incorporated herein by reference as though reproduced in its entirety.

The internal data processor 22, the capacitor 24, the photovoltaic cell 26, the liquid crystal display 28, and the biometric switch 30 will be understood to be mutually connected by suitable circuitry 32, shown in broken lines. The circuitry 32 will be understood to include all conductors, connections, and supporting elements necessary to function as described. It should be specially noted that the circuitry may include an array of conductors and terminating contacts serving as a data communication link 34 for connecting the internal data processor 22 and other electrical components of the personal account card 10 to the external data handling system, and to external electrical power if desired. The data communication link 34 may extend to the exterior of the body 14, such as to the edge 36, for subsequent connection to the external data handling system, and to the machine readable element exemplified by the magnetic strip 12.

Turning now to FIG. 2, the personal account card 10 may comprise a docking station 38, for interfacing between the personal account card 10 and other separate data handling devices (to be described hereinafter). The docking station 38 may comprise a conventional signal transferring apparatus or data connector (not shown) for making communicable contact with the data communication link 34 of the personal account card 10, and a data bus 40 for connection to a separate data handling system, the data bus 40 comprising a terminal 42 disposed to mechanically interfit with and communicably link to the data port of the separate data handling system. Data ports use industry standard terminals and connectors. Hence, the terminal 42 may be any selected one of a number of industry standard connection devices. For example, the terminal 42 may be configured to cooperate with a universal serial bus port.

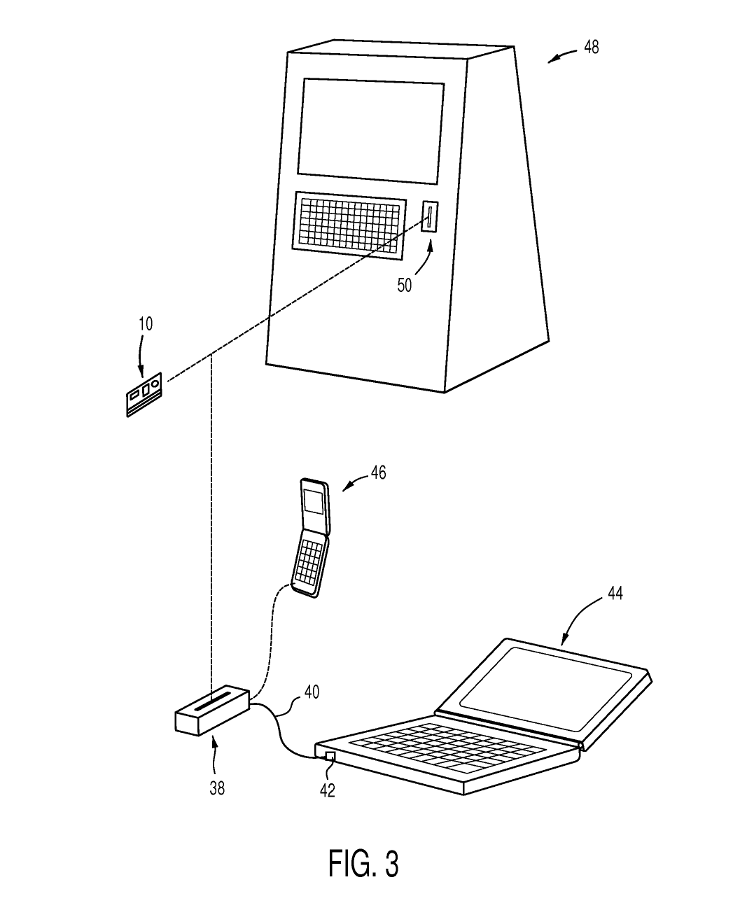

Turning now to FIG. 3, the personal account card 10 may comprise or be used in conjunction with a separate data handling system or device. The separate data handling system or device may comprise a personal computer such as a portable computer, for example, a laptop computer 44. As an alternative, and which alternative may be used in addition to as well as instead of the personal computer, the separate data handling system may comprise a portable communications device such as a cellular telephone 46. Further, the separate data handling system or device may comprise a store located or similarly situated kiosk (not shown) that is set-up to accomplish the data handling tasks provided by the personal computer and cellular telephone.

The personal account card 10 may be of the type used to operate an automatic teller machine 48 in conventional fashion. In addition to this conventional use, the personal account card 10 may interface with the separate data handling system and interact therewith to conduct operations involving transfer of data.

For example, the internal data processor 22 may comprise programming or computer instructions having functionality of maintaining balances of financial accounts such as credit accounts, debit accounts, savings accounts, checking accounts, and automatic teller accounts, the latter including subaccounts. A subaccount is an account which may draw on funds from an automatic teller account, but which may have constraints such as fund access limits which limit withdrawals to less than the maximum available funds, where such constraints do not apply to the main account. Also, access to a subaccount may utilize a procedure, password or other attribute which is different from those to be used with the main account.

The internal data processor 22 may comprise programming having functionality of displaying notices from financial institutions, or from any institution operating or contributing to operation of the external data handling system which has the card reader such as the card reader 50 of the automatic teller machine. Other examples of external data handling systems using card readers include point of sale terminals at retail stores, and security systems having card readers for authorizing entry or access.

The internal data processor 22 may comprise programming having functionality of recording receipt data available from the data terminal, such as point of sale terminals, whether free standing or integrated into a device such as a fuel pump of a fuel station.

The internal data processor 22 may comprise programming having functionality of transferring funds from one financial account to another financial account. Fund transfer, as employed herein, refers to transfers from an account of one party to an account of another, as well as from one account of a party to another account of the same party. An example of transfers from the account of one party to that of another party includes payments made in the course of retail sales and like commercial transactions. Examples of transfers among accounts of the same party include transfers among savings accounts, checking accounts, credit accounts, debit accounts, and automatic teller machine accounts.

The internal data processor 22 may comprise programming having functionality of reading external charge levying devices such as credit card and debit card terminals, barcodes printed on invoices, and others. Information so gleaned may be displayed on the liquid crystal display 28.

The internal data processor 22 may comprise programming having functionality of causing the display such as the liquid crystal display 28 to read out balance information pertaining to a financial account upon validated activation. The internal data processor 22 may comprise programming having functionality of reading out a symbol or other indicia indicating failure to establish validation in the event that an invalid attempt is made to activate the personal account card 10 by operating the on-off switch. For example, the biometric switch 30 may be arranged to respond both to pressure of a fingertip or thumb pressed thereagainst, and may then require a predetermined match of biometric characteristics to complete activation of the personal account card 10.

The internal data processor 22 may comprise programming having functionality of transferring data from the external data handling system to the internal data processor 22 of the personal account card 10 in the manner of the personal computer 44 or the cellular telephone 46 for example.

The internal data processor 22 may comprise programming having functionality of deleting data from the machine readable element which may be that device located at the magnetic strip 12 after a predetermined time delay interval to assure security of that data.

An advantageous application of the present invention is to establish secured transfers. For example, payments for unemployment benefits and social security benefits may be expedited using the above apparatus and systems. Unemployment payments are presently not payable by direct deposit. Paper checks, especially if delivered by mail, are subject to theft. The present invention therefore provides a secure, expedited way to transfer funds for purposes such as unemployment and social security benefit payments.

The present invention is susceptible to modifications and variations which may be introduced thereto without departing from the inventive concepts. For example, while the novel personal account card 10 has been presented in terms configuration of a typical credit or debit card, other configurations and dimensions may be utilized.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

We claim:

1. A personal account card having machine readable identity indicia disposed thereon, for activating an external data handling system having a data terminal including a card reader, comprising:
a flat thin body having length, width, and nominal thickness;
a machine readable element located on the flat thin body and disposed to communicate a unique identity to the card reader;
an internal data processor having memory and data processing functionality;
a data communication link for connecting the internal data processor to the external data handling system, wherein said data communication link is connected to the internal processor and extends to the exterior of the body for subsequent connection to the external data handling system; and
a power supply disposed to provide operating power to the internal data processor.

2. The personal account card of claim 1, wherein the power supply is selected from the group consisting of a photovoltaic cell or an electrical power storage device.

3. The personal account card of claim 1, further comprising a display screen which is operably connected to the internal data processor.

4. The personal account card of claim 3, wherein the display screen comprises a liquid crystal display

5. The personal account card of claim 1, further comprising an on-off switch disposed to control operation of the internal data processor.

6. The personal account card of claim 1, wherein the on-off switch comprises a biometric switch.

7. The personal account card of claim 1, wherein the machine readable element comprises a magnetic strip.

8. The personal account card of claim 1, further comprising a docking station therefor, wherein the docking station comprises a data connector disposed to communicate with the data communication link, and a data bus for connection to a separate data handling system, wherein the data bus comprises a terminal disposed to mechanically interfit with and communicably link to the data port of the separate data handling system.

9. The personal account card of claim 8, further comprising a separate data handling system.

10. The personal account card of claim 9, wherein the separate data handling system is selected from the group consisting of a personal computer, kiosk, or portable communications device.

11. The personal account card of claim 1, wherein the internal data processor comprises programming having functionality of maintaining balances of financial accounts.

12. The personal account card of claim 1, wherein the internal data processor comprises programming having functionality of displaying notices from an institution which operates or contributes to operation of the external data handling system comprising the data terminal and the card reader when the personal account card is operably inserted into the data terminal.

13. The personal account card of claim 1, wherein the internal data processor comprises programming having functionality of recording receipt data available from the data terminal.

14. The personal account card of claim 1, wherein the internal data processor comprises programming having functionality of transferring funds from one financial account to another financial account.

15. The personal account card of claim 1, wherein the internal data processor comprises programming having functionality of reading external charge levying devices.

16. The personal account card of claim 1, wherein the internal data processor comprises programming having functionality of causing the display to read out balance information pertaining to a financial account upon validated activation.

17. The personal account card of claim 1, wherein the internal data processor comprises programming having functionality of reading out a symbol indicating failure to establish validation in the event that an invalid attempt is made to activate the personal account card.

18. The personal account card of claim 1, wherein the internal data processor comprises programming having functionality of transferring data from the external data handling system to the internal data processor of the personal account card.

19. The personal account card of claim 1, wherein the internal data processor comprises programming having functionality of deleting data from the machine readable element after a time delay interval.
